(19) United States
(12) Patent Application Publication
(10) Pub. No.: US 2013/0239326 A1
(43) Pub. Date: Sep. 19, 2013

(54) Resilient and Deformable, Normal and Laterally Biased, Exercise Mat Usable by a Person when Applying a Weighted Object

(71) Applicant: Michael Boggiano, Austin, TX (US)

(72) Inventor: Michael Boggiano, Austin, TX (US)

(21) Appl. No.: 13/422,029

(22) Filed: Mar. 16, 2012

(51) Int. Cl. A47G 9/06; G09F 3/00

(52) U.S. Cl. 5/417

(57) ABSTRACT

According to one embodiment, an exercise mat is provided. The mat is impact resistant, deformable, resilient to tears or breakage, and can apply normal and lateral biasing forces onto an object received by the mat. Upward extending protrusions, indicia, or designs assist in the normal and laterally biased forces. The mat can vary in shape and dimension, and can be used indoors or outdoors. The weight of mat is such that it can be easily carried and is preferably, a 3′ diameter circular shape or a rectangular shape with at least one side 3′, but can be larger or smaller depending on the user's preference.

### BACKGROUND OF THE INVENTION

1. Field of the Invention

This invention relates to a exercise equipment and, particularly, exercise mats. The exercise mat is made of a material that is both resilient and deformable, and can bias itself against both normal and lateral forces applied thereto.

2. Description of the Related Art

The following descriptions and examples are given as background only.

Numerous types of mats are used in the exercise industry. In general, such mats can accommodate a person, either in the standing or prone position, in order to protect that person against impact from a hard floor surface. Many mats can be rolled up and stored when not in use. Not only can exercise mats protect a person against floor impact, but also shield the floor from sweat and other bacteria absorbed within the mat itself.

Conventional mats are generally not durable enough to withstand excessive repeated impact from a weighted object. In addition, such mats are not resilient enough to bias the object back to its position prior to impact. In many applications, it is important not only to bias the object in the normal force vector direction, but also in a lateral direction so as to keep the object from glancing off the mat and onto the adjacent floor surface.

Therefore, a need exists for an exercise mat that is resilient and durable to excessive repeated impacts (e.g., thousands to possibly hundreds of thousands) and can deform at each impact sufficient to bias the object back toward its original position in the normal and lateral directions.

### SUMMARY OF THE INVENTION

The problems outlined above are solved by an exercise mat that is designed to have a bottom surface that can securely contact a floor, yet no adhesive backing material is required. The bottom surface can also be secured against a wall if desired. Generally speaking, the front surface can have protrusions. It is desirable that the protusions be circular, and extend hemispherically upward from the front surface. There may be other protrusions associated with written indicia, for example, that can be included on the front surface.

The protrusions can extend as part of the mat material and, therefore, the overall mat including the protrusions and indicia can be of a singular, unibody construction. If so, the overall mat is preferably constructed of a single-molded foam material. In a preferred embodiment, the foam material can be made of ethylene-vinyl acetate or, alternatively, a rubber foaming material can be used in an extruded mold that is fashioned using an upper and lower tool or plates.

According to another embodiment, the protrusions and indicia can be made from a material of different density and resiliency than the mat, and the overall mat can be extruded with apertures to receive the protrusions or indicia which can be secured therein and extended to any desired distance from the front surface depending upon the amount of biasing desired. If advantageous, the protrusions can be adjusted in the field or by the manufacturer. In this fashion, the protrusions and indicia can be changed in accordance with the desired mat functionality or aesthetics. Alternatively though not preferred, the end user can manually cut-out apertures if, for example, multiple alternative designs are desired for the protrusions and indicia.

It is desirable that the protrusions be circular in a hemispherical shape. The hemispherical shape can have a rounded or flattened upper portion depending on the user's preference and mat functionality. A circular protrusion is preferred so that the angle of lateral impact is equally resilient in all directions. For example, a square protrusion would give a greater lateral resilience in one direction than another.

The outer dimensions of the mat can be circular, square, or rectangular. Regardless of the outer dimensions, it is desirable that the innermost region of the mat have circular protrusions and the outermost region of the mat can have indicia, such as alphabetic characters or other designs, or rectangular protrusions. Since a weighted object will most likely strike the innermost portion of the mat, the circular protrusions provide a greater benefit than the non-circular protrusions at the outermost region, not only with regard to any lateral bias provided by the circular shape, but also to the weighted object itself.

According to one embodiment, an exercise mat is provided. In this embodiment, the mat can be circular. The exercise mat comprises indicia on a front surface of the mat which can extend in an arcuate pattern proximate to an edge of the mat. A center protrusion is also provided proximate to a center of the front surface of the mat. A plurality of substantially circular protrusions are also provided which extend from the front surface of the mat between the edge of the mat and the center protrusion. The indicia preferably comprises at least two alphabetic characters spaced from each other. In one embodiment, the alphabetic characters can extend radially outward toward the edge of the mat. The circular protrusions can be located at predetermined distances from each other that can vary depending on their proximity to the center protrusion and the indicia. Depending on the orientation of the mat, the indicia and circular protrusions can provide opposing vertical and horizontal forces when impacted by a weighted object. The horizontal force can be a lateral force to provide frictional resistance when impacted by a weighted object, such as an exercise ball or foot.

According to another embodiment, an exercise mat is provided. In this embodiment, the mat can be rectangular or square. The exercise mat can include indicia on a front surface of the mat which extends in a substantially straight direction proximate to an edge of the mat. The exercise mat can further include rectangular protrusions on the front surface proximate each edge of the mat as well as circular protrusions proximate the center of the mat that can be surrounded by the rectangular protrusions.

### BRIEF DESCRIPTION OF THE DRAWINGS

Other objects and advantages of the invention will become apparent upon reading the following detailed description and upon reference to the accompanying drawings in which:

FIG. 1 illustrates a top plan view of an exercise mat according to one embodiment;

FIG. 2A illustrates a cross-sectional view along plane 2 of FIG. 1 according to one embodiment;

FIG. 2B illustrates a cross-sectional view along plane 2 of FIG. 1 according to another embodiment;

FIG. 2C illustrates a cross-sectional view along plane 2 of FIG. 1 according to yet another embodiment;

FIG. 3A illustrates a side perspective view along plane 2 of FIG. 1 showing a deformable object applied at an acute angle to a region of the exercise mat;

FIG. 3B illustrates a side perspective view along plane 2 of FIG. 1 showing a rigid object applied at an acute angle to a region of the exercise mat;

FIG. 4 illustrates a side perspective view along plane 2 of FIG. 1 showing the lateral forces and biasing of the resilient and deformable exercise mat applied to the object in order to direct the object back toward its original position;

FIG. 5 illustrates a side perspective view of an exercise mat illustrating frictional resistance when struck by an object, such as a person's foot;

FIG. 6 is a top plan view of an exercise mat according to another embodiment; and

FIG. 7 illustrates a cross-sectional view along plane 7 of FIG. 6.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF PREFERRED EMBODIMENTS

The following description of various embodiments of exercise mats is not to be construed in any way as limiting the subject matter of the appended claims.

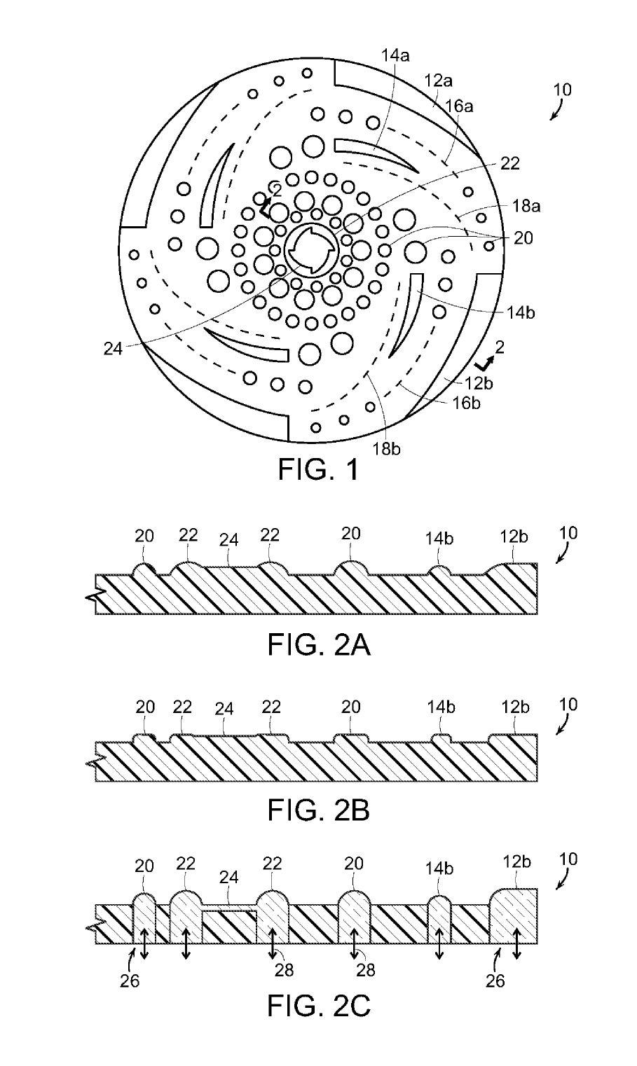

FIG. 1 illustrates an exercise mat 10 according to one embodiment. Mat 10 has a front surface and a back surface (not shown). The front surface is illustrated in FIG. 1 with design features 12a-12b and 14a-14b spaced along the circumference of mat 10. It is appreciated that additional or fewer design features are possible. It is desirable that the design features be raised or extended from the front surface and be made of the same material as the mat body. Further illustrated is indicia 16a-16b and 18a-18b which preferably extends in an arcuate pattern near the outer circumference of mat 10. It is appreciated that additional or fewer indicia are possible. Similar to design features 12/14, indicia 16/18 are preferably raised or extended from the front surface and are made of the same material as the mat body. An example of indicia 16 is the phrase “SLAM MAT.” An example of indicia 18 might be the name of the mat manufacturer or seller.

Also illustrated is a plurality of protrusions 20 which are preferably raised or extended from the front surface of mat 10 and are spaced from each other. Protrusions 20 are preferably circular in shape having a hemispherical upper surface, according to one embodiment. While many protrusions 20 can exist near design features 12/14 and indicia 16/18, it is preferred that most of the protrusions 20 occur in the region between a center protrusion 22 and indicia 16/18. By congregating protrusions 20 in this fashion, the majority of strikes upon mat 10 are accommodated by protrusions 20 having a hemispherical upper dimension and contour. Having protrusions 20 in a circular, hemispherical contour, lends to their omni-directional biasing features and allows a striking object, such as a weighted ball, to return to its original position after being thrown by a person standing above the mat, for example. Avoiding sharp edges helps eliminate any non-consistent frictional forces applied to an object in the lateral direction, regardless of the direction in which the object is applied to mat 10. Sharp edges, such as corners or certain letters of the alphabet contained in design features 12/14 or indicia 16/18, could prevent the object from returning to its original position.

Center protrusion 22 is also preferably circular in shape with an inner dimension 24 that can vary in size. According to an alternative embodiment, center protrusion 22 can also vary in size. Inner dimension 24 can preferably form a design, such as that shown in FIG. 1. Preferably, inner dimension 24 is recessed into center protrusion 22. According to a preferred embodiment, the inner dimension 24 of center protrusion 22 can provide lateral frictional resistance when impacted by a weighted object.

Preferably, mat 10, design features 12/14, indicia 16/18, protrusions 20, center protrusion 22, and inner dimension 24 are all formed in a single molded or extruded process within the confines of a tool that stamps a molded material to form a unibody construction. The material is preferably an EVA material, such as ethylene-vinyl acetate or any suitable rubber foaming material which has an elasticity and is resilient to many thousands of strikes by an object, such as a weighted ball, yet is deformable at each strike. The various features formed on the front surface of mat 10 provide both normal and lateral biasing against any object thrown or applied against mat 10.

FIG. 2A is a cross-sectional view of mat 10 along plane 2 of FIG. 1 which illustrates the different sizes of protrusions 20 with a rounded, hemispherical upper surface. Also illustrated are the inner and outer diameters of center protrusion 22 along with recessed inner dimension 24. Further illustrated are indicia 14 and design feature 12. As shown in the alternative embodiment of FIG. 2B, protrusions 20, center protrusion 22, indicia 14, and design feature 12 can have a flattened upper surface. Regardless of whether the various features are rounded or flattened, they can all be formed as part of the molding process as a single unibody construction.

According to an alternative embodiment as illustrated in FIG. 2C, the various features on the front surface of mat 10 can be formed separate from the mat body. As shown, the front surface of mat 10 contains apertures or openings 26 formed as part of the molding process or after the molding process by manually cutting out the openings. Regardless of when the apertures or openings are provided, protrusions 20, center protrusion 22 with recessed dimension 24, indicia 14, and design feature 12 can be inserted into the openings 26. The elements inserted into openings 26 can be made of a different material than the body of mat 10, such as a material with a different density, resiliency, and/or deformability, for example, in order to adjust for any increase or decrease in lateral forces striking mat 10. Moreover, the depth of the elements inserted into openings 26 can be adjusted, as shown by arrows 28, if desired depending on the amount of normal and lateral biasing needed. It is appreciated that each of the elements inserted into openings 26 can be adjusted independently of each other.

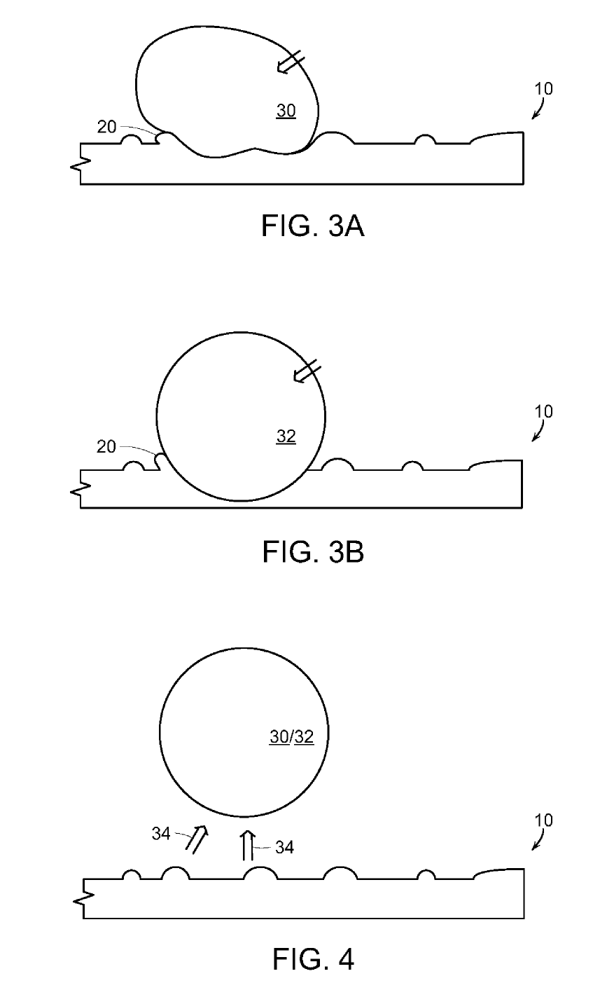

FIGS. 3A-3B illustrate the feature of deformability and resiliency associated with mat 10. FIG. 3A illustrates the application of an object, such as a deformable ball 30, upon mat 10. Ball 30 deforms and extends partially into the front surface of mat 10. In this fashion, ball 30 grasps the lateral sides of a protrusion 20, causing protrusion 20 to deform laterally yet maintaining frictional resistance against ball 30, thus preventing ball 30 from deflecting in the opposite direction. FIG. 3B illustrates the application of an object, such as a weighted ball 32, upon mat 10. The deformability of mat 10 and protrusion 20 not only prevents ball 32 from deflecting in the opposite direction, but also protects ball 32 from damage caused by a hard surface, for example. Even if ball 32 is substantially heavy, for example 50-70 pounds, the density of the foam material forming mat 10 allows it to be substantially resilient against damage. The preferred EVA material forming mat 10 is of such density that there is insignificant damage or wear to the front surface of mat 10 even after being stricken by a weighted object multiple time. Furthermore, such material is non-porous to water, such as rain or sweat, for example, which prevents the spread of bacteria or viruses. Accordingly, mat 10 can be used both outside and inside.

FIG. 4 illustrates the reciprocal forces 34 applied by mat 10 to an object, such as ball 30 or ball 32. Forces 34 are attributable to the lateral forces of the various elements, such as protrusions 20, and the normal or perpendicular forces associated with the material which forms mat 10. Depending on the weight of the object 30 or 32, the ball can bounce back to its original position if the angle at which the ball is thrown is no more than, for example, 20° from perpendicular. If greater than 20° from perpendicular, the ball will bounce slightly off perpendicular, but still easily retrievable by the user due to the advantages of the raised elements, such as protrusions 20, which laterally force the ball back toward its original position.

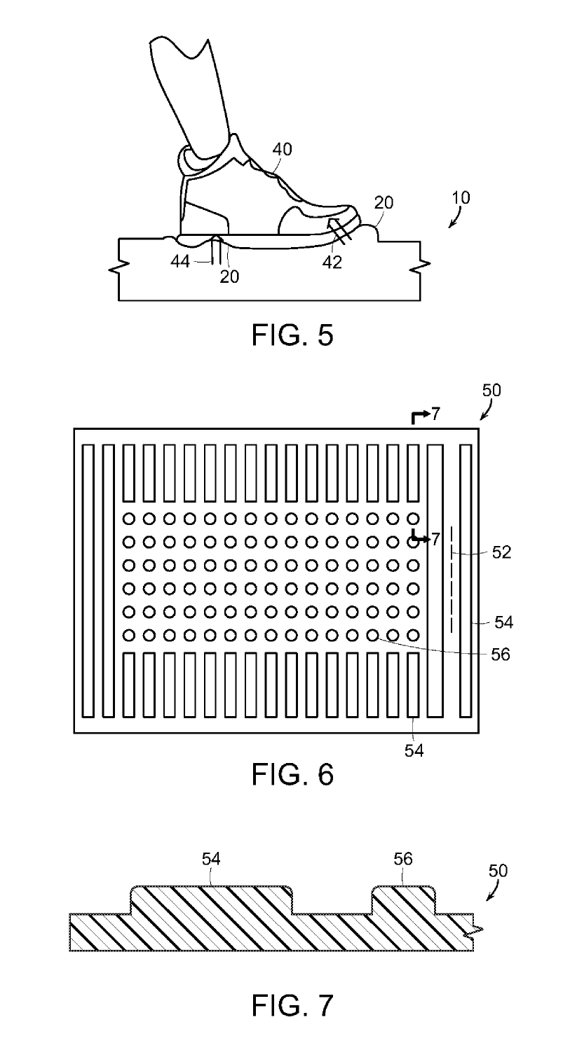

FIG. 5 illustrates a further use of mat 10. Protrusions 20 can prevent a user's foot 40 from sliding off mat 10 as shown by arrow 42, and can further be used to apply normal or perpendicular force as shown by arrow 44. When a person uses mat 10 while standing, for example, the force vector associated with force 42 allows such person to maintain their position, and when jumping, for example, the force vector associated with force 44 causes additional upward and lateral biasing which reduces impact and stress to the joints of that person.

FIG. 6 illustrates an alternative embodiment of an exercise mat. Mat 50 is a rectangular shape. Mat 50 is shown with indicia 52, rectangular protrusions 54, and circular protrusions 56. Although the preferred embodiment of mat 50 is illustrated, it is appreciated that the protrusions can be of different shapes, such as square or oval, for example, with the same or dissimilar dimensions.

FIG. 7 is a cross-sectional view of mat 50 along plane 7 of FIG. 6 which illustrates rectangular protrusion 54 and circular protrusion 56. Mat 50 is preferably of the same chemical composition and construction as mat 10, either as a single unibody structure or as a structure with apertures to receive the various protrusions. Preferably, protrusions 54/56 have a raised, flat surface for use by a person while standing or jumping. However, it is appreciated that the protrusions can be of a raised, spherical shape depending on the application.

Further modifications and alternative embodiments of various aspects of the invention will be apparent to those skilled in the art in view of this description. It is intended that the following claims be interpreted to embrace all such modifications and changes and, accordingly, the specification and drawings are to be regarded in an illustrative rather than a restrictive sense.

What is claimed is:

1. An exercise mat, comprising:
indicia on a front surface of the mat and extending in an arcuate pattern proximate to an edge of the mat;
a center protrusion proximate to a center of the front surface of the mat; and
a plurality of substantially circular protrusions on the front surface spaced between the edge of the mat and the center protrusion.

2. The exercise mat according to claim 1, wherein the indicia comprises at least two alphabetic characters spaced from each other.

3. The exercise mat according to claim 1, wherein the indicia further extends radially outward toward the edge of the mat.

4. The exercise mat according to claim 1, wherein the circular protrusions are located at predetermined distances from each other that vary depending on their proximity to the center protrusion and the indicia.

5. The exercise mat according to claim 1, wherein the circular protrusions each comprise a substantially hemispherical-shaped surface of dissimilar dimensions extending from the front surface, said dimensions varying depending on their proximity to the center protrusion and indicia.

6. The exercise mat according to claim 1, wherein the indicia and circular protrusions provide opposing vertical and horizontal forces when impacted by a weighted object, wherein the horizontal force is a lateral force to provide frictional resistance when impacted by a weighted object such as an exercise ball or foot.

7. The exercise mat according to claim 1, wherein the center protrusion is substantially circular with a constant or varying outer and inner diameters to provide lateral frictional resistance when impacted by a weighted object.

8. The exercise mat according to claim 1 is of a unibody construction and manufactured as a single molded foam material inclusive of the indicia, center protrusion, and plurality of circular protrusions.

9. The exercise mat according to claim 1 is a unibody construction and manufactured as a single molded foam material with apertures for receiving the protrusions having a density and elasticity different from the exercise mat and whereby the protrusions can be adjusted within the apertures to extend at differing distance from the front surface.

10. An exercise mat, comprising:
indicia on a front surface of the mat and extending in a substantially straight direction proximate to an edge of the mat;
rectangular protrusions on the front surface proximate each edge of the mat; and
circular protrusions on the front surface of the mat proximate the center of the mat and surrounded by the rectangular protrusions.

11. The exercise mat according to claim 10, wherein the indicia comprises at least two alphabetic characters spaced from each other.

12. The exercise mat according to claim 10, wherein the rectangular protrusions and circular protrusions provide an impact resistant surface.

13. The exercise mat according to claim 10, wherein the surface can be used by a person when standing or jumping.

14. The exercise mat according to claim 10, wherein the circular protrusions are located at substantially similar distances apart and are substantially hemispherical-shaped surface extending from the front surface.

15. The exercise mat according to claim 10, wherein at least some of the circular and rectangular protrusions are of substantially similar dimensions.

16. The exercise mat according to claim 10 is of a unibody construction and manufactured as a single molded foam material inclusive of the indicia, rectangular and circular protrusions.

17. The exercise mat according to claim 10, wherein the circular protrusions each comprise a hemisphere of dissimilar dimensions.

18. The exercise mat according to claim 10, wherein the rectangular protrusions are of dissimilar dimensions.

19. The exercise mat according to claim 10, is a unibody construction and manufactured as a single molded foam material with apertures for receiving the protrusions having a density and elasticity different from the exercise mat and whereby the protrusions can be adjusted within the apertures to extend at differing distance from the front surface.

20. The exercise mat according to claim 10, wherein the indicia, rectangular and circular protrusions provide upward and lateral resistive force against an object applied vertically and horizontally against the front surface.
